(19) United States
(12) Patent Application Publication
(10) Pub. No.: US 2002/0151613 A1
(43) Pub. Date: Oct. 17, 2002

(54) Preparation of low-odor flexible polyurethane foams

(76) Inventors: Peter Falke, Schwarzheide (DE); Heinz-Jurgen Schroder, Meuro (DE); Lothar Baum, Schwarzheide (DE); Steffen Klippert, Schwarzheide (DE)

Correspondence Address: BASF CORPORATION, LEGAL DEPARTMENT, 1609 BIDDLE AVENUE, WYANDOTTE, MI, 48192, US

(21) Appl. No.: 10/046,808

(22) Filed: Jan. 15, 2002

(30) Foreign Application Priority Data
Feb. 6, 2001 (DE) 10105557.9

(51) Int. Cl. C08G 18/00

(52) U.S. Cl. 521/155

(57) ABSTRACT

Low-odor flexible polyurethane foams are prepared by reacting organic and/or modified organic polyisocyanate (a) with a polyetherol mixture (b) and, if required, further compounds (c) having hydrogen atoms reactive toward isocyanates, in the presence of water and/or other blowing agents (d), catalysts (e), flameproofing agents (f) and, if required, further assistants and additives (g), by a process in which the polyetherol mixture (e) consists of

b1) at least one difunctional to octafunctional polyetherol based on ethylene oxide and, if required, propylene oxide and/or butylene oxide, having an ethylene oxide content of at least 30% by weight, based on the total amount of alkylene oxide used, and an OH number of from 20 to 200 mg KOH/g, and

b2) at least one polyetherol based on propylene oxide and/or butylene oxide and, if required, ethylene oxide, having an OH number greater than 20 mg KOH/g, the ethylene oxide content being less than 30% by weight, based on the total amount of alkylene oxide used,

and the foaming is effected in an index range of less than 150, the catalyst used comprising at least one catalyst supporting the polyisocyanurate reaction.

The flexible polyurethane foams thus prepared are used as carpet, upholstery, seat and packaging material and in the hygiene sector.

The present invention relates to a process for the preparation of low-odor flexible polyurethane foams by reacting organic and/or modified organic polyisocyanates (a) with a special polyetherol mixture (b) and, if required, further compounds (c) having hydrogen atoms reactive toward isocyanates, in the presence of water and/or other blowing agents (d), catalysts (e), flameproofing agents (f) and, if required, further assistants and additives (g) and their use as carpet, upholstery and seat material.

The preparation of polyurethane foams by reacting organic and/or modified organic polyisocyanates or prepolymers with compounds having a higher functionality and at least two reactive hydrogen atoms, for example polyoxyalkylenepolyamines and/or preferably organic polyhydroxy compounds, in particular polyetherols, and, if required, chain extenders and/or crosslinking agents in the presence of catalysts, blowing agents, flameproofing agents, assistants and/or additives is known and has been widely described. A comprehensive overview of the preparation of polyurethane foams is given, for example, in Kunststoff-Handbuch, Volume VII, Polyurethane, 1st Edition 1966, edited by Dr. R. Vieweg and Dr. A. Höchtlen, and 2nd Edition, 1983, and 3rd Edition 1993, edited in each case by Dr. G. Oertel (Carl Hanser Verlag, Munich).

Flexible polyurethane foams having isocyanurate groups which are also referred to as PIR foams—have a straw-like feel owing to the isocyanurate groups. Flexible polyurethane foams are used predominantly for the production of seat elements and upholstery materials.

WO-A-9821254 describes foams which were prepared using a combination of tin catalyst and an alkali metal salt. Such a catalyst combination is said to result in foams which are more stable but which have to be milled.

U.S. Pat. No. 5,539,011 discloses slabstock foams based on polyetheralcohols having predominantly secondary OH groups. The use of incorporatable catalysts and added trimerization catalysts is said to result in reduced rigidity of the flexible foams.

U.S. Pat. No. 3,943,075 describes the use of TDI and PIR catalysts based on alkali metal for producing flameproofed flexible foams. The novel polyol mixture leads only to nonshrink products if from 2 to 40% of a polyol mixture comprises an ethylene oxide-rich polyol. A halogen-containing compound, e.g. trichloropropyl phosphate, must be present as a process assistant.

U.S. Pat. No. 4,981,880 discloses a very flexible low-density foam. Considerable amounts of a monofunctional polyetheralcohol are used. In addition to a PIR catalyst, typical urethane catalysts are used. Owing to the monofunctional foam and the large amounts of water used, poor properties are to be expected.

U.S. Pat. No. 4,098,732 describes flexible PIR foams which are said to have a low stack gas density. In addition to alkaline earth metal salts as PIR catalysts, a polyol combination which also comprises polyols having a molecular weight greater than 3 000 g/mol is used, and the main polyols should have more than 50% of primary OH groups and be used in combination with a polyol which has more than 50% of secondary OH groups. Low molecular weight polyols are also present. The polyols used are based on polyoxypropylene oxide polyols having an ethylene oxide endcap.

WO-A-9424184 describes flexible foams which are produced in the presence of catalytically active amounts of alkali metal salts or alkaline earth metal salts. With the aid of a special isocyanate which contains more than 85% of 4,4′-MDI, it is said to be possible to produce open-cell flexible foams also with ethylene oxide-rich polyols. For this purpose, polypropylene glycol is reacted with maleic anhydride beforehand and is neutralized with alkali metal salts. Polyols having an ethylene oxide content of less than 20% by weight are used.

GB 2107336 discloses the preparation of flexible foams in the presence of alkali metal salts. Polypropylene glycols, which may contain proportionate amounts of ethylene oxide, are used as polyols.

CA 2154622 mentions potassium salts of amino acids, which have to be prepared and purified beforehand in an expensive process, as special PIR catalysts which are said to lead to improved PIR foams. Tin compounds serve as cocatalysts. In addition, the foams give a substantially semirigid impression.

In WO-A-9518163, prepolymers based on polyphenylene polyisocyanate and an ethylene oxide-containing polyol are used. This measure is said to serve for achieving improved adhesion to top layers. In particular, proportionate amounts of perfluoroalkanes are used as blowing agents.

DE-A-2607380 describes polyisocyanurate foams which are produced using large amounts of CFCs. Polyetherols which may contain up to 50% of ethylene oxide are also used.

WO-A-9821256 and WO-A-9821260 describe rigid foams having low rigidity, which assume the character of flexible foams after a milling process. These formulations use minor amounts of polyols containing ethylene oxide.

According to the present prior art, it is difficult to produce high-quality low-odor flexible foams using ethylene oxide-rich polyetherols.

It is an object of the present invention to use ethylene oxide-rich polyols to prepare low-odor flexible polyurethane foams which, in spite of the high proportions of ethylene oxide-containing polyols, permit foaming to give low-odor flexible foams having good mechanical and flameproof properties.

We have found that this object is surprisingly achieved by virtue of the fact that the reactivity behavior of the polyurethane component could be established and low-odor flexible foams could be prepared by using the novel combination of the polyols (b), consisting of at least one difunctional to octafunctional polyetherol based on ethylene oxide and, if required, propylene oxide and/or butylene oxide, having an ethylene oxide content of at least 30% by weight, based on the total amount of alkylene oxide used, and an OH number of from 20 to 200 mg KOH/g (b1) and at least one polyetherol based on propylene oxide and/or butylene oxide and, if required, ethylene oxide, having an OH number greater than 20 mg KOH/g, the ethylene oxide content being less than 30% by weight, based on the total amount of alkylene oxide used, (b2), and a suitable catalyst system which in any case contains a PIR catalyst, preferably a potassium salt and in particular potassium acetate, and foaming in an index range of less than 150.

The present invention therefore relates to a process for the preparation of low-odor flexible polyurethane foams by reacting organic and/or modified organic polyisocyanates (a) with a polyetherol mixture (b) and, if required, further compounds (c) having hydrogen atoms reactive toward isocyanates, in the presence of water and/or other blowing agents (d), catalysts (e), flameproofing agents (f) and, if required, further assistants and additives (g), wherein the polyetherol mixture (b) consists of

b1) at least one difunctional to octafunctional polyetherol based on ethylene oxide and, if required, propylene oxide and/or butylene oxide, having an ethylene oxide content of at least 30% by weight, based on the total amount of alkylene oxide used, and an OH number of from 20 to 200 mg KOH/g, and

b2) at least one polyetherol based on propylene oxide and/or butylene oxide and, if required, ethylene oxide, having an OH number greater than 20 mg KOH/g, the ethylene oxide content being less than 30% by weight, based on the total amount of alkylene oxide used,

and the foaming is effected in an index range of less than 150, the catalyst used comprising at least one catalyst supporting the polyisocyanurate reaction.

The present invention furthermore relates to the flexible polyurethane foams themselves which are produced in this manner and their use as carpet, upholstery, seat and packaging material and in the hygiene sector.

In our investigations, we have found, surprisingly, that a low-odor flexible foam which contains urethane, urea and isocyanurate groups and has in particular an improved odor in addition to good mechanical properties results when the novel combination of the polyetherols (b) is employed, a PIR catalyst is used and the novel index range is maintained. The fact that a flexible foam could be produced and good rise and curing behavior of the foam was observed in the absence of amine catalysts or, if required, with the concomitant use of very small amounts of such catalysts was particularly surprising. This was not to be expected since the PIR catalysts used according to the invention generally require a higher activation energy in order to initiate the reaction of the reactants.

Regarding the components used according to the invention in the polyol mixture, the following may be stated:

The component (b1) consists of at least one difunctional to octafunctional polyetherol based on ethylene oxide and, if required, propylene oxide and/or butylene oxide, having an ethylene oxide content of more than 30, preferably more than 60, % by weight, based in each case on the total amount of alkylene oxide used, and an OH number of from 20 to 200, preferably from 30 to 60, mg KOH/g. Advantageously, the polyol (b1) contains more than 30%, preferably from 40 to 90%, of primary OH groups.

For example, the following are suitable as (b1): polyetherols based on ethylene glycol, glycerol or trimethylolpropane as an initiator, having an ethylene oxide block or randomly incorporated ethylene oxide. Polyetherols based on glycerol with an ethylene oxide endcap are preferably used, but a propylene oxide endcap can also be used.

The polyetherols (b1) are preferably used in amounts of more than 30, in particular more than 50, particularly preferably from 60 to 90, % by weight, based in each case on the total weight of the component (b).

The component (b2) consists of at least one polyetherol which is at least difunctional and is based on propylene oxide and/or butylene oxide and, if required, ethylene oxide, the ethylene oxide content being less than 30, preferably less than 25, % by weight, and has an OH number greater than 20, preferably greater than 30, mg KOH/g.

For example, the following are suitable as (b2): polyetherols based on propylene glycol, glycerol, tolylenediamine and sorbitol and propylene oxide, it being possible for a proportionate amount of ethylene oxide to be present. Polyetheralcohols based on propylene oxide with propylene glycol as initiator are preferably used.

The polyetherols (b2) are preferably used in amounts of less than 70, in particular less than 30, particularly preferably less than 20, % by weight, based on the total weight of the component (b).

Said polyetherols are prepared by known proceses, as described by way of example further below.

The novel low-odor flexible polyurethane foams prepared by reacting organic and/or modified organic polyisocyanates (a) with the polyetherol mixture (b) described above and, if required, further compounds (c) having hydrogen atoms reactive toward isocyanates, in the presence of water and/or other blowing agents (d), catalysts (e), flameproofing agents (f) and, if required, further assistants and additives (g).

The foams are prepared, according to the invention, with indices of less than 150, preferably from 50 to 150, particularly preferably from 60 to 110.

Regarding the further starting components which may be used, the following may be stated specifically:

Suitable organic polyisocyanates (a) for the preparation of the novel polyurethane are the aliphatic, cycloaliphatic, araliphatic and preferably aromatic polyfunctional isocyanates known per se.

Specific examples are alkylene diisocyanates having 4 to 12 carbon atoms in the alkylene radical, such as dodecane 1,12-diisocyanate, 2-ethyltetramethylene 1,4-diisocyanate, 2-methylpentamethylene 1,5-diisocyanate, tetramethylene 1,4-diisocyanate and preferably hexamethylene 1,6-diisocyanate; cycloaliphatic diisocyanates, such as cyclohexane 1,3- and 1,4-diisocyanate and any desired mixtures of these isomers, 1-isocyanato-3,3,5-trimethyl-5-isocyanatomethylcyclohexane (IPDI), hexahydrotolylene 2,4- and 2,6-diisocyanate and the corresponding isomer mixtures, dicyclohexylmethane 4,4′-, 2,2′- and 2,4′-diisocyanate and the corresponding isomer mixtures, and preferably aromatic di- and polyisocyanates, such as tolylene 2,4- and 2,6-diisocyanate and the corresponding isomer mixtures, diphenylmethane 4,4′-, 2,4′- and 2,2′-diisocyanate and the corresponding isomer mixtures, mixtures of diphenylmethane 4,4′- and 2,2′-diisocyanates, polyphenylpolymethylene polyisocyanates, mixtures of diphenylmethane 4,4′-, 2,4′- and 2,2′-diisocyanates and polyphenylpolymethylene isocyanates (crude MDI) and mixtures of crude MDI and tolylene diisocyanates. The organic di- and polyisocyanates can be used individually or in the form of their mixtures.

Tolylene diisocyanate, mixtures of diphenylmethane diisocyanate isomers, mixtures of diphenylmethane diisocyanate and crude MDI or tolylene diisocyanate with diphenylmethane diisocyanate and/or crude MDI are preferably used. Mixtures containing more than 30% by weight of diphenylmethane 2,4′-diisocyanates are particularly preferably used.

Frequently, modified polyfunctional isocyanates, i.e. products which are obtained by chemical reaction of organic di- and/or polyisocyanates, are also used. Examples are di- and/or polyisocyanates containing ester, urea, biuret, allophanate, carbodiimide, isocyanurate, uretdione and/or urethane groups. The following specific examples are suitable: organic, preferably aromatic, polyisocyanates containing urethane groups having NCO contents of from 43 to 15, preferably from 31 to 21, % by weight, based on the total weight, diphenylmethane 4,4′-diisocyanate, diphenylmethane 4,4′- and 2,4′-diisocyanate mixtures, crude MDI or tolylene 2,4- or 2,6-diisocyanate, each of which is modified by reaction with, for example, low molecular weight diols, triols, dialkylene glycols, trialkylene glycols or polyoxyalkylene glycols having molecular weights of up to 6 000, in particular up to 1 500. The di- and polyoxyalkylene glycols can be used individually or as mixtures, for example diethylene and dipropylene glycol and polyoxyethylene, polyoxypropylene and polyoxypropylene polyoxyethylene glycols, -triols and/or -tetrols. Also suitable are NCO-containing prepolymers having NCO contents of from 25 to 3.5, preferably from 21 to 14, % by weight, based on the total weight, prepared from the polyesterpolyols and/or preferably polyetherpolyols described below and diphenylmethane 4,4′-diisocyanate, mixtures of diphenylmethane 2,4′- and 4,4′-diisocyanate, tolylene 2,4- and/or 2,6-diisocyanates or crude MDI. Liquid polyisocyanates containing carbodiimide groups and/or isocyanurate rings and having NCO contents of from 43 to 15, preferably from 31 to 21, % by weight, based on the total weight, for example based on diphenylmethane 4,4′-, 2,4′- and/or 2,2′-diisocyanate and/or tolylene 2,4- and/or 2,6-diisocyanate, have also proved useful.

The modified polyisocyanates can be mixed with one another or with unmodified organic polyisocynates, e.g. diphenylmethane 2,4′- and 4,4′-diisocyanate, crude MDI or tolylene 2,4- and/or 2,6-diisocyanate.

NCO-containing prepolymers which are advantageously formed by reaction of at least parts of the components (a), (b) and, if required, (c) and/or (d), in particular those which contain at least a proportionate amount of the component (b1), have proven particularly useful as modified organic polyisocyanates.

In addition to the polyetherol mixture (b) described above when used according to the invention, further compounds (c) having hydrogen atoms reactive toward isocyanates are added if required.

Compounds having at least two reactive hydrogen atoms are primarily suitable for this purpose. Those having a functionality of from 2 to 8, preferably from 2 to 3, and an average molecular weight of from 300 to 8 000, preferably from 300 to 5 000, are expediently used. The hydroxyl number of the polyhydroxy compounds is as a rule from 20 to 160, preferably from 28 to 56.

The polyetherpolyols used in components (b) and (c) are prepared by known processes, for example by anionic polymerization with alkali metal hydroxides, e.g. sodium hydroxide, potassium hydroxide, or alkali metal alcoholates, e.g. sodium methylate, sodium ethylene, potassium ethylate and potassium isopropylate, as catalysts and with addition of at least one initiator which contains from 2 to 8, preferably 2 or 3, reactive hydrogen atoms bonded per molecule, or by cationic polymerization with Lewis acids, such as antimony pentachloride, boron fluoride etherate, etc., or bleaching earth as catalysts or by double metal cyanide catalysis from one or more alkylene oxides having 2 to 4 carbon atoms in the alkylene radical. For special purposes, it is also possible to incorporate monofunctional initiators into the polyether structure.

Suitable alkylene oxides are, for example, tetrahydrofuran, 1,3-propylene oxide, 1,2- and 2,3-butylene oxide, styrene oxide and preferably ethylene oxide and 1,2-propylene oxide. The alkylene oxides may be used individually, alternately in succession or as mixtures.

Examples of suitable initiator molecules are water, organic dicarboxylic acids, such as succinic acid, adipic acid, phthalic acid and terephthalic acid, aliphatic and aromatic, unsubstituted or N-monoalkyl-, N,N-dialkyl- and N,N′-dialkyl-substituted diamines having 1 to 4 carbon atoms in the alkyl radial, such as unsubstituted or monoalkyl- and dialkyl-substituted ethylenediamine, diethylenetriamine, triethylenetetramine, 1,3-propylenediamine, 1,3- and 1,4-butylenediamine, 1,2-, 1,3-, 1,4-, 1,5- and 1,6-hexamethylenediamine, phenylenediamine, 2,3-, 2,4- and 2,6-tolylenediamine and 4,4′-, 2,4′- and 2,2′-diaminodiphenylmethane. Other suitable initiator molecules are alkanolamines, e.g. ethanolamine, N-methyl- and N-ethylethanolamine, dialkanolamines, e.g. diethanolamine, N-methyl- and N-ethyldiethanolamine, and trialkanolamines, e.g. triethanolamine, and ammonia. Polyhydric, in particular dihydric and/or trihydric, alcohols, such as ethanediol, 1,2- and 2,3-propanediol, diethylene glycol, dipropylene glycol, 1,4-butanediol, 1,6-hexanediol, glycerol, trimethylolpropane and pentaerythritol are preferably used.

The polyetherpolyols, preferably polyoxypropylene- and polyoxypropylenepolyoxyethylenepolyols, have a functionality of, preferably, from 2 to 8, in particular from 2 to 3, and molecular weights of from 300 to 8 000, preferably from 300 to 6 000, in particular from 1 000 to 5 000, and suitable polyoxytetramethylene glycols have a molecular weight of about 3 500.

Other suitable polyetherpolyols are polymer-modified polyetherpolyols, preferably graft polyetherpolyols, in particular those based on styrene and/or acrylonitrile, which are prepared by in situ polymerization of acrylonitrile, styrene or preferably mixtures of styrene and acrylonitrile, for example in a weight ratio of from 90:10 to 10:90, preferably from 70:30 to 30:70, expediently in the abovementioned polyetherpolyols, analogously to German Patents 1111394, 1222669 (U.S. Pat. Nos. 3,304,273, 3,383,351, 3,523,093), 1152536 (GB 1040452) and 1152537 (GB 987618), and polyetherpolyols dispersions which contain, as the disperse phase, usually in an amount of from 1 to 50, preferably from 2 to 25, % by weight, for example, polyureas, polyhydrazides, polyurethanes containing bonded tert-amino groups and/or melamine and which are described, for example, in EP-B-011752 (U.S. Pat. No. 4,304,708), U.S. Pat. No. 4,374,209 and DE-A-3231497.

The polyetherpolyols can be used individually or in the form of mixtures.

In addition to the polyetherpolyols described, for example, polyetherpolyamines and/or further polyols selected from the group consisting of the polyesterpolyols, polythioetherpolyols, polyesteramides, hydroxyl-containing polyacetals and hydroxyl-containing aliphatic carbonates or mixtures of at least two of said polyols may also be used. The hydroxyl number of the polyhydroxy compounds is as a rule from 20 to 80, preferably from 28 to 56.

Suitable polyesterpolyols can be prepared, for example, from organic dicarboxylic acids of 2 to 12 carbon atoms, preferably aliphatic dicarboxylic acids of 4 to 6 carbon atoms, polyhydric alcohols, preferably diols, of 2 to 12, preferably 2 to 6, carbon atoms, by conventional processes. Usually, the organic polycarboxylic acids and/or derivatives thereof and polyhydric alcohols are subjected to polycondensation, advantageously in a molar ratio of from 1:1 to 1:1.8, preferably from 1:1.05 to 1:1.2, in the absence of a catalyst or preferably in the presence of an esterification catalyst, expediently in an atmosphere comprising inert gas, e.g. nitrogen, carbon monoxide, helium, argon, etc. in the melt at from 150 to 250° C., preferably from 180 to 220° C., if required under reduced pressure, up to the desired acid number, which is advantageously less than 10, preferably less than 2.

Examples of suitable hydroxyl-containing polyacetals are the compounds which can be prepared from glycols, such as diethylene glycol, triethylene glycol, 4,4′-dihydroxyethoxydiphenyldimethylmethane and hexanediol, and formaldehyde. Suitable polyacetals can also be prepared by a polymerization of cyclic acetals. Suitable hydroxyl-containing polycarbonates are those of the type known per se, which can be prepared, for example, by reacting diols, such as 1,3-propanediol, 1,4-butanediol and/or 1,6-hexanediol, diethylene glycol, triethylene glycol or tetraethylene glycol with diaryl carbonates, e.g. diphenyl carbonate, or phosgene. The polyesteramides include, for example, the predominantly linear condensates obtained from polybasic, saturated and/or unsaturated carboxylic acids or their anhydrides and polyhydric saturated or unsaturated amino alcohols or mixtures of polyhydric alcohols and amino alcohols and/or polyamines. Suitable polyetherpolyamines can be prepared from the abovementioned polyetherpolyols by known processes. Examples are the cyanoalkylation of polyoxyalkylenepolyols and subsequent hydrogenation of the nitrile formed (U.S. Pat. No. 3,267,050) or the partial or complete amination of polyoxyalkylenepolyols with amines or ammonia in the presence of hydrogen and catalysts (DE-A-1215373).

The compounds of component (c) can be used individually or in the form of mixtures.

The low-odor flexible polyurethane foams can be prepared in the presence or absence of chain extenders and/or crosslinking agents, but these are generally not required. The chain extenders and/or crosslinking agents used are diols and/or triols having molecular weights of less than 400, preferably less from 60 to 300. For example, aliphatic, cycloaliphatic and/or araliphatic diols of 2 to 14, preferably 4 to 10, carbon atoms, e.g. ethylene glycol, 1,3-propanediol, 1,10-decanediol, o-, m- and p-dihydroxycyclohexane, diethylene glycol, dipropylene glycol and preferably 1,4-butanediol, 1,6-hexanediol and bis(2-hydroxyethyl)hydroquinone, triols, such as 1,2,4- and 1,3,5-trihydroxycyclohexane, triethanolamine, diethanolamine, glycerol and trimethylolpropane and low molecular weight hydroxyl-containing polyalkylene oxides based on ethylene oxide and/or 1,2-propylene oxide and the abovementioned diols and/or triols are suitable as initiator molecules.

If the polyurethane foams are prepared using chain extenders, crosslinking agents or mixtures thereof, these are expediently used in an amount of up to 10% by weight, based on the weight of the polyol compounds.

According to the invention, water is used as blowing agent (d), in amounts of from 1 to 10, preferably from 1 to 5, particularly preferably from 2 to 4, % by weight, based in each case on the total weight of the components (b) to (g).

The water can be added in combination with other conventional blowing agents. For example, the chlorofluorocarbons (CFCs) generally known from polyurethane chemistry, and highly fluorinated and/or perfluorinated hydrocarbons, are suitable for this purpose. However, the use of these substances is greatly restricted or has been completely discontinued for ecological reasons. In addition to chlorofluorocarbons and fluorocarbons, in particular aliphatic and/or cycloaliphatic hydrocarbons, especially pentane and cyclopentane, or acetals, e.g. methylal, are possible alternative blowing agents. These physical blowing agents are usually added to the polyol component of the system. However, they may also be added in the isocyanate component or as a combination of both the polyol component and the isocyanate component. It is also possible to use them together with highly fluorinated and/or perfluorinated hydrocarbons, in the form of an emulsion of the polyol component. Emulsifiers, where they are used, are usually oligomeric acrylates which contain polyoxyalkylene and fluoroalkane radicals bonded as side groups and have a fluorine content of from about 5 to 30% by weight. Such products are sufficiently well known from plastics chemistry, e.g. EP-A-0351614. The amount of blowing agent or blowing agent mixture which may be used in addition to water is advantageously from 1 to 10, preferably from 1 to 3, % by weight, based in each case on the total weight of the components (b) to (d).

In particular, compounds which greatly accelerate the reaction of the reactive hydrogen atoms, in particular of hydroxyl-containing compounds of components (b), (c) and (d) with the organic, unmodified or modified polyisocyanates (a) are used as catalysts (e) for the preparation of the low-odor flexible polyurethane foams.

According to the invention, at least one catalyst supporting the polyisocyanurate reaction (PIR catalyst) is used. Preferably, alkali metal and/or alkaline earth metal compounds, in particular alkali metal salts, for example potassium acetate, potassium octanoate and potassium formate, are used. Potassium acetate is preferably used.

Further alkali metal and/or alkaline earth metal compounds to be used according to the invention include alkali metal hydroxides, such as sodium hydroxide, and alkali metal alcoholates, such as sodium methylate and potassium isopropylate, and alkali metal salts of long-chain fatty acids having 10 to 20 carbon atoms and, if required, OH side groups.

Other known PIR catalysts, such as tris(dialkylaminoalkyl)-s-hexahydrotriazines, in particular tris(N,N-dimethylaminopropyl)-s-hexahydrotriazine, and tetraalkylammonium hydroxides, such as tetramethylammonium hydroxide, are also suitable.

In addition to the PIR catalysts, further catalysts customary in polyurethane chemistry may be present. For example, the following are suitable for this purpose: organic metal compounds, preferably organic tin compounds, such as tin(II) salts of organic carboxylic acids, e.g. tin(II) acetate, tin(II) octanoate, tin(II) ethylhexanoate and tin(II) laurate, and the dialkyltin(IV) salts of organic carboxylic acids, e.g. dibutyltin diacetate, dibutyltin dilaurate, dibutyltin maleate and dioctyltin diacetate.

The organic metal compounds are used alone or in combination with strongly basic amines. Examples are amidines, such as 2,3-dimethyl-3,4,5,6-tetrahydropyrimidine, tertiary amines, such as triethylamine, tributylamine, dimethylbenzylamine, N-methyl-, N-ethyl- and N-cyclohexylmorpholine, N,N,N′,N′-tetramethylethylenediamine, N,N,N′,N′-tetramethylbutanediamine, N,N,N′,N′-tetramethylhexane-1,6-diamine, pentamethyldiethylenetriamine, tetramethyldiaminoethyl ether, bis(dimethylaminopropyl)urea, dimethylpiperazine, 1,2-dimethylimidazole and 1-azabicyclo[3.3.0]octane, and aminoalkanol compounds, such as triethanolamine, triisopropanolamine, N-methyl- and N-ethyldiethanolamine and dimethylethanolamine, which serve as blowing catalysts and in particular favor the reaction of the isocyanates with the water.

Diazabicycloundecane and preferably 1,4-diazabicyclo[2.2.2]octane (Dabco) are used as gel catalysts. These catalysts accelerate the reaction of the isocyanate with the polyols.

Advantageously, amine catalysts are dispensed with.

If, in addition to the PIR catalysts used according to the invention, further catalysts customary in polyurethane chemistry are present, they are preferably used in amounts of not more than 0.5% by weight, based on the weight of the components (b) to (g).

Altogether, the total amount of catalyst combination is preferably less than 2, in particular less than 1, % by weight, based on the weight of the components (b) to (g).

For the preparation of the novel low-odor flexible polyurethane foams, halogen-free flameproofing agents are preferably used as flameproofing agents (f). Ammonium polyphosphate, aluminum hydroxide, isocyanurate derivates and carbonates of alkaline earth metals are particularly suitable for this purpose. Melamine and mixtures of melamine and expanded graphite are preferably used.

Novel foams can of course also be prepared if, in addition to the preferably used halogen-free flameproofing agents, further halogen-containing flameproofing agents known in polyurethane chemistry are used or concomitantly used, for example tricresyl phosphate, tris(2-chloroethyl) phosphate, tris(2-chloropropyl) phosphate, tetrakis(2-chloroethyl) ethylene diphosphate, dimethyl methanephosphonate, diethyl diethanolaminomethylphosphonate and commercial halogen-containing polyol flameproofing agents. In addition to the abovementioned halogen-substituted phosphates, further inorganic or organic flameproofing agents, such as red phosphorus, hydrated alumina, antimony trioxide, arsenic oxide, calcium sulfate, corn starch and/or, if required, aromatic polyesters, can also be used for flameproofing the polyisocyanate polyadducts.

In general, it has proven expedient to use a total of up to 35, preferably up to 20, parts by weight, including advantageously at least 80% of the flameproofing agents preferred according to the invention, per 100 parts by weight of the components (b) to (g).

If required, further assistants and/or additives (g) may be incorporated in the reaction mixture for the preparation of novel flexible polyurethane foams. Examples are stabilizers, fillers, dyes, pigments and hydrolysis stabilizers as well as fungistatic and bacteriostatic substances.

Stabilizers used are in particular surfactants, i.e. compounds which serve for supporting the homogenization of the starting materials and may also be suitable for regulating the cell structure of the plastics. Examples are emulsifiers, such as the sodium salts of castor oil sulfates or fatty acids and salts of fatty acids with amines, for example oleic acid with diethylamine, of stearic acid with diethanolamin and of ricinoleic acid with diethanolamine, salts of sulfonic acids, for example alkali metal and ammonium salts of dodecylbenzene- or dinaphthylmethanedisulfonic acid and ricinoleic acid; foam stabilizers, such as siloxane/oxyalkylene copolymers and other organopolysiloxanes, oxyethylated alkylphenols, oxyethylated fatty alcohols, liquid paraffins, castor oil esters and ricinoleic acid esters, turkey red oil and groundnut oil, and cell regulators, such as paraffins, fatty alcohols and dimethylpolysiloxanes. Predominantly used stabilizers are organopolysiloxanes which are water-soluble. These have polydimethylsiloxane radicals onto which a polyether chain comprising ethylene oxide and propylene oxide has been grafted. The surfactants are usually used in amounts of from 0.01 to 5 parts by weight, based on 100 parts by weight of the components (b) to (g).

Fillers, in particular reinforcing fillers, are to be understood as meaning the conventional organic and inorganic fillers, reinforcing agents, weighting agents, agents for improving the abrasion behavior in paints, coating materials, etc., which are known per se. Specific examples are inorganic fillers, such as silicate minerals, for example sheet silicates, such as antigorite, serpentine, hornblendes, amphiboles, chrysotile and talc, metal oxides, such as kaolin, aluminas, titanium oxides and iron oxides, metal salts, such as chalk, barite and inorganic pigments, such as cadmium sulfide and zinc sulfide, and glass, etc. Kaolin (china clay), aluminum silicate and coprecipitates of barium sulfate and aluminum silicate as well as natural and synthetic fibrous minerals, such as wollastonite, metal fibers and in particular glass fibers of various lengths, which, if required, may be sized, are preferably used. Examples of suitable organic fillers are carbon, rosin, cyclopentadienyl resins and graft polymers and cellulose fibers, polyamide, polyacrylonitrile, polyurethane and polyester fibers based on aromatic and/or aliphatic dicarboxylic esters, and in particular carbon fibers. The inorganic and organic fillers may be used individually or as mixtures and are incorporated into the reaction mixture advantageously in amounts of from 0.5 to 50, preferably from 1 to 40, % by weight, based on the weight of the components (a) to (g), but the content of matts, nonwovens and woven fabrics of natural and synthetic fibers may reach values of up to 80.

More detailed information about the abovementioned other conventional assistants and additives can be found in the technical literature, for example the monograph by J. H. Saunders and K. C. Frisch, High Polymers, Volume XVI, Polyurethanes, Parts 1 and 2, Interscience Publishers 1962 and 1964, or the above-cited Kunststoffhandbuch, Polyurethane, Volume VII, Hanser-Verlag, Munich, Vienna, 1st to 3rd Editions.

For the preparation of the novel foams, the organic and/or modified inorganic polyisocyanates (a), the polyetherol mixture (b) and, if required, further compounds (c) having hydrogen atoms reactive toward isocyanates and further components (d) to (g) are reacted in amounts such that the ratio of the number of equivalents of NCO groups of the polyisocyantes (a) to the sum of the reactive hydrogen atoms of the components (b) to (g) is less than 1.5:1, preferably from 0.4:1 to 0.9:1.

Polyurethane foams according to the novel process are advantageously prepared by the one-shot method, for example with the aid of the high pressure or low pressure technique, in open or closed molds, for example metallic molds. The continuous application of the reaction mixture to suitable belt lines for producing slabstock foam is also usual.

It has proven particularly advantageous to employ the two-component process and to combine the components (b) to (g) to give a polyol component, often referred to as component A, and to use the organic and/or modified organic polyisocyanates (a), particularly preferably an NCO prepolymer or mixtures of prepolymer and further polyisocyanates, and, if required, blowing agents (d) as the isocyanate component, often also referred to as component (b).

The starting components are mixed at from 15 to 90° C., preferably from 20 to 60° C., in particular from 20 to 35° C., and are introduced into the open mold or, if required, under superatmospheric pressure into the closed mold, or, in the case of a continuous line, are applied to a belt which receives the reaction material. Mixing can be effected mechanically by means of a stirrer, by means of a stirring screw or by high-pressure mixing in a nozzle. The mold temperature is expediently from 20 to 110° C., preferably from 30 to 60° C., in particular from 35 to 55° C.

The low-odor polyurethane foams prepared by the novel process and containing urethane, urea and isocyanurate groups have a density of from 20 to 100, preferably from 35 to 70, in particular from 40 to 60, kg/m³.

Even with the exclusive use of PIR catalysts, it is possible to prepare foams having a soft feel.

Because amine catalysts are not used or are used in extremely small amounts, they have little or no emission, which is otherwise encountered in the case of standard flexible foams.

They are particularly suitable as carpet, upholstery, seat and packaging materials and for applications in the hygiene sector.

The examples which follow illustrate the invention but without restricting it.

### EXAMPLES

A mixture of 40 parts by weight of Lupranat® M20A and 60 parts by weight of Lupranat® MI served in each case as the isocyanate component.

TABLE 1

| Experiment | 1 | 2 | 3 | 4 | 5 |
|---|---|---|---|---|---|
| Polyol b1 | 77.1 | 76.8 | 76.8 | 76.4 | 75.9 |
| Polyol b2(a) | 4 | 4 | 4 | 4 | 4 |
| Polyol b2(b) | 14 | 14 | 14 | 14 | 14 |
| Lupragen ® N201 | 0.1 | | | 0.1 | 0.1 |
| Lupragen ® VP 9104 | 0.3 | 0.5 | 0.5 | 1 | 0.5 |
| DC 198 | 1.5 | 1.5 | 1.5 | 1.5 | |
| B 8409 | | | | | 2.5 |
| Water | 3 | 3 | 3 | 3 | 3 |
| Cream time | 16 | 12 | 12 | 7 | 12 |
| Rise time | 180 | 130 | 125 | 55 | 120 |
| Index | 105 | 105 | 120 | 105 | 105 |

It is evident that the reaction time can be adjusted within a wide range by modifying the amount of PIR catalyst and, if required, also concomitantly using Lupragen® N201. All foams are open-cell and completely shrink-free.

TABLE 2

| Experiment | | 6 | 7 | 8 | 9 | 10 |
|---|---|---|---|---|---|---|
| Polyol b1 | | 76 | 76 | 76 | 76 | 76 |
| Polyol b2(a) | | 4 | 4 | | | |
| Polyol b2(b) | | 14 | 14 | 18 | 18 | 14 |
| Polyol b2(c) | | | | | | 4 |
| Lupragen ® VP 9104 | | 0.5 | 0.5 | 0.5 | 0.5 | 0.5 |
| B 8409 | | 2.5 | 2.5 | 2.5 | 2.5 | 2.5 |
| Water | | 3 | 3 | 3 | 3 | 3 |
| Index | | 95 | 75 | 86 | 95 | 95 |
| Density | kg/m³ | 44.4 | 51.7 | 48.5 | 43.9 | 42.5 |
| Tensile strength | kPa | 43.6 | 17.5 | 34.8 | 70.1 | 74 |
| Elongation at break | % | 401 | 415 | 280 | 146 | 175 |
| Resilience | % | 9.8 | 6.8 | 10.3 | 16.8 | 16.3 |
| Compression set | % | 48.11 | 52.51 | 30.67 | 4.96 | 17.35 |
| Hysteresis | % | 48.5 | 60 | 38 | 44.1 | 45.5 |
| Compressive strength | kPa | 0.65 | 0.3 | 0.86 | 3.38 | 2.82 |
| Odor | Rating 1-5 | 1.5 | 1.5 | 1.5 | 2 | 2 |

Samples 6-10 freely foamed;

| | |
|---|---|
| Odor: | |
| Rating 1 - | no odor detectable, |
| Rating 5 - | very strong odor; |
| Polyol b1 - | OH number 42 mg KOH/g, Polyetheralcohol |
| | based on propylene oxide and ethylene oxide |
| | (72% by weight), glycerol initiator, amount of |
| | primary OH groups 77% (BASF) |
| Polyol b2(a) - | OH number 55 mg KOH/g, Polyetheralcohol |
| | based on propylene oxide and ethylene oxide |
| | (10% by weight), glycerol initiator (BASF); |
| Polyol b2(b) - | OH number 55 mg KOH/g, Polyetheralcohol |
| | based on propylene oxide, propylene glycol |
| | initiator (BASF); |
| Polyol b2(c) - | OH number 35 mg KOH/g, Polyetheralcohol |
| | based on propylene oxide and ethylene oxide |
| | (13% by weight), glycerol initiator (BASF); |
| Lupragen ® VP 9104 - | PIR catalyst based on potassium acetate; |
| Lupragen ® N 201 - | Gel catalyst in ethylene glycol (33%) (BASF); |
| DC 198 - | Silicone stabilizer (Air Products); |
| B 8409 - | Silicone stabilizer (Goldschmidt); |
| Lupranat ® MI - | NCO content 33.6% by weight, isomer mix- |
| | ture of 4,4′-MDI and 2,4′-MDI; |
| Lupranat ® M20A - | NCO content 31.6% by weight, |
| | polyphenylenepolymethylene polyisocyanate. |

We claim:—

1. A process for the preparation of low-odor flexible polyurethane foams by reacting organic and/or modified organic polyisocyanates (a) with a polyetherol mixture (b) and, if required, further compounds (c) having hydrogen atoms reactive toward isocyanates, in the presence of water and/or other blowing agents (d), catalysts (e), flameproofing agents (f) and, if required, further assistants and additives (g), wherein the polyetherol mixture (b) consists of
b1) at least one difunctional to octafunctional polyetherol based on ethylene oxide and, if required, propylene oxide and/or butylene oxide, having an ethylene oxide content of at least 30% by weight, based on the total amount of alkylene oxide used, and an OH number of from 20 to 200 mg KOH/g, and
b2) at least one polyetherol based on propylene oxide and/or butylene oxide and, if required, ethylene oxide, having an OH number greater than 20 mg KOH/g, the ethylene oxide content being less than 30% by weight, based on the total amount of alkylene oxide used,
and the foaming is effected in an index range of less than 150, the catalyst used comprising at least one catalyst supporting the polyisocyanurate reaction.

2. A process as claimed in claim 1, wherein the ethylene oxide content of the polyol (b1) is more than 60% by weight, based on the total amount of alkylene oxide used.

3. A process as claimed in claim 1 or 2, wherein the polyol (b1) has more than 30% of primary OH groups.

4. A process as claimed in any of claims 1 to 3, wherein the polyol (b1) is used in amounts of at least 30% by weight, based on the total weight of the component (b).

5. A process as claimed in any of claims 1 to 4, wherein the polyol (b2) is used in amounts of less than 70% by weight, based on the total weight of the component (b).

6. A process as claimed in any of claims 1 to 5, wherein water is used as blowing agent (d) in amounts of from 1 to 10, preferably from 1 to 5, % by weight, based on the total weight of the components (b) to (g).

7. A process as claimed in any of claims 1 to 5, wherein the catalyst (e) used is an alkali metal salt and/or alkaline earth metal salt.

8. A process as claimed in any of claims 1 to 5, wherein the catalyst (e) used is potassium acetate.

9. A process as claimed in any of claims 1 to 8, wherein the flameproofing agents (f) are halogen-free.

10. A process as claimed in any of claims 1 to 9, wherein the flameproofing agents (f) used are melamine and, if required, expanded graphite.

11. A process as claimed in any of claims 1 to 10, wherein the organic and/or modified organic polyisocyanates (a) used are tolylene diisocyanate, mixtures of diphenylmethane diisocyanate isomers, mixtures of diphenylmethane diisocyanate and polyphenylpolymethylene polyisocyanate or tolylene diisocyanate with diphenylmethane diisocyanate and/or polyphenylpolymethylene polyisocyanate.

12. A process as claimed in any of claims 1 to 10, wherein the organic and/or modified organic polyisocyanates (a) used are NCO-containing prepolymers formed from the reaction of the isocyanates (a) with the polyetherols (b) and, if required, components (c) and/or (d).

13. A process as claimed in any of claims 1 to 12, wherein the foaming is effected in an index range of from 50 to 150.

14. A low-odor flexible polyurethane foam, which can be prepared as claimed in any of claims 1 to 13.

15. The use of a flexible polyurethane foam as claimed in claim 14 as carpet, upholstery, seat and packaging material and in the hygiene sector.
